(19) United States
(12) Patent Application Publication
(10) Pub. No.: US 2018/0225287 A1
(43) Pub. Date: Aug. 9, 2018

(54) SYSTEM AND METHOD FOR LANGUAGE TRANSLATION

(71) Applicants: Robert Golda, Aurora, IL (US); Shawn Herndon, Aurora, IL (US)

(72) Inventors: Robert Golda, Aurora, IL (US); Shawn Herndon, Aurora, IL (US)

(21) Appl. No.: 15/426,219

(22) Filed: Feb. 7, 2017

(51) Int. Cl. G06F 17/28

(52) U.S. Cl. CPC G06F 17/2836

(57) ABSTRACT

A method for language translation that includes the steps of: retrieving a first language audio input through a portable electronic device (PED); processing the first language audio input via a processor within the PED; generating a translated audio clip of the first language audio input into a second language audio clip; and transmitting the translated language audio clip to a receiver. The PED may be a smartphone or a tablet and the receiver may be an earpiece.

### BACKGROUND OF THE INVENTION

### Description of Related Art

The present invention relates to a system and method for translating language.

### Field of Invention

The present invention relates to a software application accessible through a portable electronic device that effectively translates the first language into a second language.

### DESCRIPTION OF RELATED ART

Language translation is a common requirement for communications between different speaking people. There's a number of languages used in various countries and cultures wherein some of the most widely used languages include: Indo-European languages such as English, Spanish, Italian or Russian; Eastern Asian languages such as Chinese, Mandarin, Korean or Japanese; African languages such as Swahili, Shana, Yoruba; Semitic languages of Arabic, Hebrew; languages of Southeast Asia such as Samoan and Maore; and Turkish languages of Central Asia. As can be seen there's a number of languages throughout the world that therefore separates many cultures and countries due to language barriers. Such language barriers interfere with first communications and secondly with joint ventures and pursuits beneficiary to both cultures and countries. However, many languages may be easily translated through modern technology. Various Internet web pages have been developed to assist in translation. However such translation is usually required through an Internet connection and use of a complete computing device. As a result, it would be advantageous to have a software application developed on a portable electronic device such as a smartphone or portable tablet that could provide a tool for ready and available language translation.

### SUMMARY OF THE INVENTION

The present invention relates to a method for language translation that includes the steps of: retrieving a first language audio input through a portable electronic device (PED); processing the first language audio input via a processor within the PED; generating a translated audio clip of the first language audio input into a second language audio clip; and transmitting the translated language audio clip to a receiver. The PED may be a smartphone or a tablet and the receiver may be an earpiece.

### BRIEF DESCRIPTION OF DRAWINGS

FIG. 1 depicts an overview of a language translation system in accordance with the present invention.

### DETAILED DESCRIPTION

The present invention relates to a language translation system and method that utilizes a software application loaded onto a portable electronic device. The software application provides operating instructions for a processor and memory associated with the electronic device and functions to receive audio of a first language. The first language is then processed through the processor of the portable electronic device and outputted as audio in a second language. The output preferably is transmitted to a receiving device. The preferred receiving device is an earpiece that is used in conjunction with the portable electronic device. As a result, a user allows for the receipt of a first language through the portable electronic device, where the processing provided in the portable electronic device generates the second language output. This output is transmitted via an audio signal to the receiving device for receipt by the user. Further a second accessory may be provided used in conjunction with the portable electronic device in the form of a second audio speaker. The second audio speaker may provide an output of the first language based upon input of the second language by the user. In this manner a user may be able to converse with an individual through the electronic device.

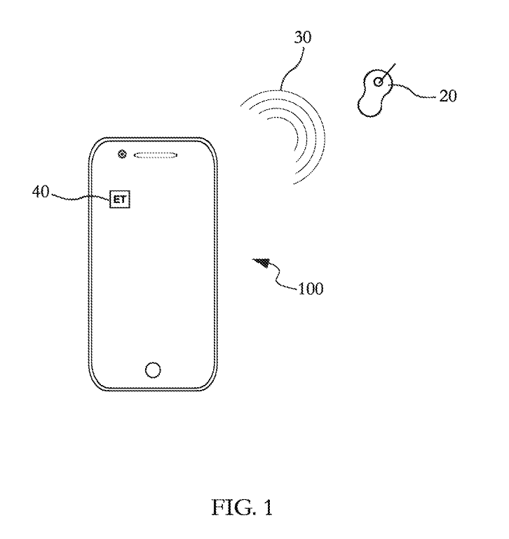

In reference to FIG. 1, an overview of the system in accordance with the present invention is depicted. The system includes a Portable Electronic Device 100. Preferably this Portable Electronic Device 100 is a smartphone or tablet that has a processor and memory sufficient to receive a Software Application 40. The Software Application 40 then functions within the Portable Electronic Device 100 to receive audio in a first language, translates the first language into a second language and outputs the translation in the second language via a Signal 30. Signal 30 is received by a Receiver 20 and may be listened to by the user. Preferably, the Receiver 20 is an earpiece and the Signal 30 is a Bluetooth or other similar RF signal that is received by the Earpiece 30.

What is claimed is:

1. A method for language translation comprising:
retrieving a first language audio input through a portable electronic device (PED);
processing the first language audio input via a processor within the PED;
generating a translated audio clip of the first language audio input into a second language audio clip; and
transmitting the translated language audio clip to a receiver.

2. The method for language translation according to claim 1, wherein the PED is a smartphone.

3. The method for language translation according to claim 1, wherein the PED is a tablet.

4. The method for language translation according to claim 1, wherein the receiver is an earpiece.

5. The method for language translation according to claim 1, wherein step of transmitting uses a RF signal.

6. The method for language translation according to claim 1, wherein step of transmitting uses a Bluetooth signal.
